(19) United States
(12) Patent Application Publication
(10) Pub. No.: US 2011/0158636 A1
(43) Pub. Date: Jun. 30, 2011

(54) LENS ASSEMBLY AND CAMERA MODULE USING THE SAME

(75) Inventor: HUNG-LUNG HO, Tu-Cheng (TW)

(73) Assignee: HON HAI PRECISION INDUSTRY CO., LTD., Tu-Cheng (TW)

(21) Appl. No.: 12/822,318

(22) Filed: Jun. 24, 2010

(30) Foreign Application Priority Data
Dec. 29, 2009 (TW) 98145416

(51) Int. Cl. G03B 17/00; G02B 9/34

(52) U.S. Cl. 396/529; 359/771

(57) ABSTRACT

A lens assembly includes a first lens, a second lens, a third lens and a fourth lens. The first lens has a first flange on a surface thereof, with the first flange having a first receiving groove. The second lens has a second flange on a surface thereof and a positioning protrusion on the other surface opposite to the second flange. The positioning protrusion is received in the first receiving groove. The second flange defines a second receiving groove. The third lens has a third flange on a surface thereof and a positioning protrusion on the other surface opposite to the third flange. The positioning protrusion is received in the second receiving groove. The fourth lens has a fourth flange on a surface thereof, and the fourth flange defines a fourth receiving groove for receiving the third flange.

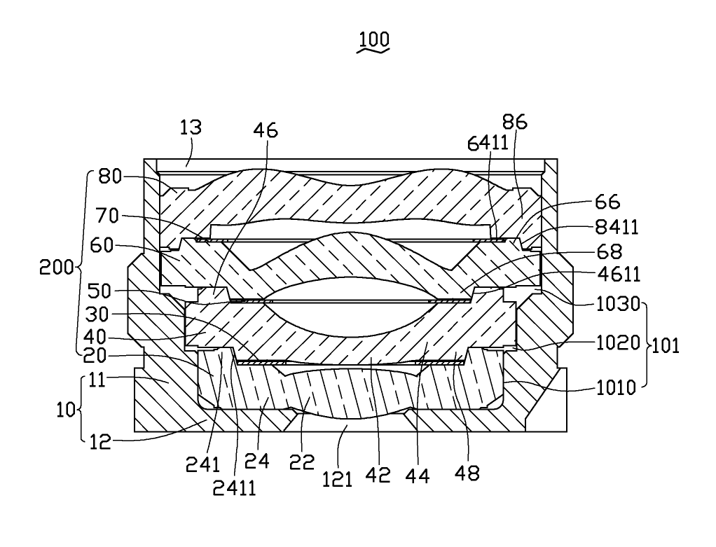

### BACKGROUND

1. Technical Field

The present disclosure relates to a lens assembly and a camera module using the lens assembly.

2. Description of the Related Art

A commonly used camera module used in a portable electronic device, such as cell phone, includes a lens and a barrel receiving the lens. The lens is fixed on an inner surface of the barrel by ultraviolet adhesive. However, due to possible errors occurring during assembly, an optical axis of the lens may deviate from the center of the barrel, and, especially when a plurality of lenses is fixed in the barrel, reduced image quality can thereby result.

Therefore, there is room for improvement within the art.

### BRIEF DESCRIPTION OF THE DRAWINGS

The components in the drawings are not necessarily drawn to scale, the emphasis instead placed upon clearly illustrating the principles of the present disclosure. Moreover, in the drawings, like reference numerals designate corresponding parts throughout the views, and both the views are schematic.

The drawing is a cross-section of an embodiment of a camera module.

### DETAILED DESCRIPTION

Referring to the drawing, an exemplary embodiment of a camera module 100 includes a barrel 10, a first lens 20, a first spacing ring 30, a second lens 40, a second spacing ring 50, a third lens 60, a third spacing ring 70 and a fourth lens 80. The barrel 10 is used for receiving the first, second, third, and fourth lenses 20, 40, 60, 80. In the illustrated embodiment, the first, second, third, and fourth lenses 20, 40, 60, 80 are made of glass. In the alternative embodiment, the first, second, third, and fourth lenses 20, 40, 60, 80 may be made of transparent resin. Each of the first, second and third spacing rings 30, 50, 70 defines a light transmitting hole (not labeled).

The barrel 10 is substantially a hollow cylinder. The barrel 10 includes a sidewall 11 and a stop wall 12 at an end of the barrel 10. The barrel 10 defines an opening 13 at a distance away from the stop wall 10 and a through hole 121 at a center of the stop wall 12. The sidewall 11 and the stop wall 12 define a receiving chamber 101 cooperatively. The receiving chamber 101 includes a first chamber 1010 for receiving the first lens 20, a second chamber 1020 for receiving the second lens 40 and a third chamber 1030 for receiving both the third lens 60 and the fourth lens 80. The first chamber 1010 is adjacent to the stop wall 12 and connects to the through hole 121, and the third chamber 1030 is away from the stop wall 12. The second chamber 1020 is between the first chamber 1010 and the third chamber 1030 and connects the first chamber 1010 and the third chamber 1030.

The first lens 20 includes an imaging portion 22 at its center and a fixing portion 24 surrounding the imaging portion 22 for fixing the first lens 20. The fixing portion 24 has a first flange 241 on a surface at a circumference of the fixing portion 24, and the first flange 241 defines a first receiving groove 2411.

The second lens 40 is similar to the first lens 20 in structure, and also includes an imaging portion 42 and a fixing portion 44 surrounding the imaging portion 42 and a second flange 46 at a circumference of the fixing portion 44. The second flange 46 defines a second receiving groove 4611. The diameter of the second lens 40 exceeds that of the first lens 20, and the second lens 40 further has a positioning protrusion 48, corresponding to the first receiving groove 2411 of the first lens 20, at the other surface opposite to the second flange 46.

The third lens 60 includes a third flange 66 on a surface at a circumference thereof and a positioning protrusion 68 at the other surface opposite to the third flange 66. The third flange 66 defines a third receiving groove 6411.

The fourth lens 80 includes a fourth flange 86 defining a fourth receiving groove 8411 for receiving the third flange 66 of the third lens 60.

In assembly, the first lens 20 is positioned in the first chamber 1010, and the first flange 241 faces away from the stop wall 12. The first spacing ring 30 is positioned on the surface on which the first flange 241 is formed. The second lens 40 is positioned in the second chamber 1020. The positioning protrusion 48 of the second lens 40 is received in the first receiving groove 2411, and contacts the first spacing ring 30. An outer surface of the positioning protrusion 48 contacts an inner surface of the first flange 241, thus preventing radial movements of the second lens 40 relative to the first lens 20. The second spacing ring 50 is positioned at the surface on which the second flange 46 is formed. The third lens 60 is positioned in the third chamber 1030 such that the positioning protrusion 68 is received in the second receiving groove 4611 and abuts the second spacing ring 50, so as to prevent radial movement of the third lens 60 relative to the second lens 40. The third spacing ring 70 is positioned in the third receiving groove 6411, and substantially coplanar with a top surface of the third flange 66. The fourth lens 80 is also positioned in the third chamber 1030 and on the third lens 60 such that the third flange 66 is received in the fourth receiving groove 8411. An outer surface of the third flange 66 contacts the inner surface of the fourth flange 8411, such that radial movement of the fourth lens 80 relative to the third lens 60 is prevented. The first lens 20, the second lens 40, the third lens 60 and the fourth lens 80 are adjacently interlocked by the respective flange received in the respective receiving groove, to form a lens assembly 200, such that the first lens 20, the second lens 40, the third lens 60 and the fourth lens 80 are coaxial with each other. The first lens 20, the second lens 40, the third lens 60 and the fourth lens 80 are fixed on an inner surface of the barrel 10 by ultraviolet adhesive. The first spacing ring 30, the second spacing ring 50 and the third spacing ring 70 block the light rays incident at the fixing portions of each lens correspondingly, so as to improve image quality.

Finally, while particular embodiments have been described, the description is illustrative and is not to be construed as limiting. For example, various modifications can be made to the embodiments by those of ordinary skill in the art without departing from the true spirit and scope of the invention as defined by the appended claims.

What is claimed is:

1. A lens assembly, comprising:
a first lens comprising a first flange on a surface thereof, the first flange defining a first receiving groove;
a second lens comprising a second flange on a surface thereof and a positioning protrusion on the other surface thereof opposite to the second flange, the second flange defining a second receiving groove, and the positioning protrusion received in the first receiving groove;
a third lens comprising a third flange on a surface thereof and a positioning protrusion on the other surface opposite to the third flange, and the positioning protrusion received in the second receiving groove; and
a fourth lens comprising a fourth flange on a surface thereof, the fourth flange defining a fourth receiving groove for receiving the third flange.

2. The lens assembly of claim 1, wherein the first lens comprises an imaging portion and a fixing portion surrounding the imaging portion, and the first flange is formed on the fixing portion.

3. The lens assembly of claim 1, further comprising a first spacing ring positioned in the first receiving groove and contacting the positioning protrusion of the second lens.

4. The lens assembly of claim 3, further comprising a second spacing ring positioned in the second receiving grove and contacting the positioning protrusion of the third lens.

5. The lens assembly of claim 4, further comprising a third spacing ring between the third and the fourth lens; the third flange defining a third receiving groove, and the third spacing ring positioned in the third receiving grove and substantially coplanar with the third flange.

6. A camera module, comprising:
a barrel and a lens assembly received in the barrel, and the lens assembly comprising:
a first lens comprising a first flange on a surface thereof, the first flange defining a first receiving groove;
a second lens comprising a second flange on a surface thereof and a positioning protrusion on the other surface thereof opposite to the second flange, the second flange defining a second receiving groove, and the positioning protrusion received in the first receiving groove;
a third lens comprising a third flange on a surface thereof and a positioning protrusion on the other surface opposite to the third flange, and the positioning protrusion received in the second receiving groove; and
a fourth lens comprising a fourth flange on a surface thereof, the fourth flange defining a fourth receiving groove for receiving the third flange.

7. The camera module of claim 6, wherein the first lens comprises an imaging portion and a fixing portion surrounding the imaging portion, and the first flange is formed on the fixing portion.

8. The camera module of claim 6, further comprising a first spacing ring between the first and the second lens, and the first spacing ring positioned in the first receiving grove and contacting the positioning protrusion of the second lens.

9. The camera module of claim 8, further comprising a second spacing ring between the second and the third lens, and the second spacing ring positioned in the second receiving grove and contacting the positioning protrusion of the third lens.

10. The camera module of claim 9, further comprising a third spacing ring between the third and the fourth lens; the third flange defining a third receiving groove, and the third spacing ring positioned in the third receiving grove and substantially coplanar with the third flange.

11. The camera module of claim 6, wherein the first lens, the second lens, the third lens and the fourth lens are fixed on an inner surface of the barrel by ultraviolet adhesive.

12. The camera module of claim 6, wherein the barrel defines a receiving chamber for receiving the lens assembly, the receiving chamber comprising a first chamber for receiving the first lens, a second chamber for receiving the second lens and the third chamber for receiving both the third and fourth lens, and the second chamber is between the first chamber and the third chamber and connects the first and the third chamber.
